(19) United States
(12) Patent Application Publication
(10) Pub. No.: US 2026/0011030 A1
(43) Pub. Date: Jan. 8, 2026

(54) HUMAN FACE DISTANCE ESTIMATION

(71) Applicant: Intel Corporation, Santa Clara, CA (US)

(72) Inventors: Shahar Shmuel Yuval, Haifa (IL); Oskar Pelc, Netanya (IL); Anatoly Litvinov, Binyamina (IL)

(73) Assignee: Intel Corporation, Santa Clara, CA (US)

(21) Appl. No.: 19/329,200

(22) Filed: Sep. 15, 2025

(51) Int. Cl. G06T 7/73; A63F 13/55; G06V 40/16

(52) U.S. Cl. CPC G06T 7/73; A63F 13/55; G06V 40/174; G06T 2207/30201

(57) ABSTRACT

Systems, apparatus, articles of manufacture, and methods are disclosed to perform human face distance estimation using a single calibrated two-dimensional (2D) camera, thereby eliminating the need for stereo depth systems, time-of-flight cameras, infrared pattern projectors, etc. Disclosed example techniques estimate three-dimensional (3D) distance from a camera to a human face by combining 2D facial landmarks, corresponding reconstructed 3D landmarks, and known anatomical distance priors such as interpupillary distance. An example multi-landmark technique that addresses occlusion issues by computing weighted-average distance estimates from multiple facial feature pairs is also disclosed. The example human face distance estimation techniques disclosed herein enable implementation of human-machine interfaces based on human face distance using standard 2D cameras with minimal software complexity.

### BACKGROUND

Estimating the distance between a device and a human face has many technological applications. For example, compute devices can utilize the distance between the device and a face of a human operator as a user input to control one or more applications.

### BRIEF DESCRIPTION OF THE DRAWINGS

FIG. 1 is a block diagram of an example environment including example facial distance estimation circuitry to estimate a distance between an example device camera and a human face.

FIG. 2 is a block diagram of an example implementation of the facial distance estimation circuitry of FIG. 1.

FIG. 3 illustrates example facial landmarks capable of being used by the facial distance estimation circuitry of FIGS. 1-2 to estimate the distance between the device camera and the human face in the example environment of FIG. 1.

FIG. 4 illustrates an example reconstructed face model generated by the facial distance estimation circuitry of FIGS. 1-2 to provide relative three-dimensional (3D) coordinates for facial landmarks used to estimate the distance between the device camera and the human face in the example environment of FIG. 1.

FIG. 5 is a block diagram of example landmark distance estimation circuitry included in the facial distance estimation circuitry of FIG. 2.

FIGS. 6-8 illustrate example geometric relationships and operations utilized by the facial distance estimation circuitry of FIGS. 1-2 to estimate the distance between the device camera and the human face in the example environment of FIG. 1.

FIGS. 9-12 are flowcharts representative of example machine-readable instructions and/or example operations that may be executed, instantiated, and/or performed by example programmable circuitry to implement the facial distance estimation circuitry of FIG. 2.

FIG. 13 is a block diagram of an example processing platform including programmable circuitry structured to execute, instantiate, and/or perform the example machine-readable instructions and/or perform the example operations of FIGS. 9-12 to implement the facial distance estimation circuitry of FIG. 2.

FIG. 14 is a block diagram of an example implementation of the programmable circuitry of FIG. 13.

FIG. 15 is a block diagram of another example implementation of the programmable circuitry of FIG. 13.

FIG. 16 is a block diagram of an example software/firmware/instructions distribution platform (e.g., one or more servers) to distribute software, instructions, and/or firmware (e.g., corresponding to the example machine-readable instructions of FIGS. 9-12) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Estimating the distance between a device and a human face has many technological applications. For example, compute devices, such as computers, gaming consoles, smartphones, etc., can utilize the distance between the device and a face of a human operator as a user input to control one or more applications, such as gaming applications, security applications, etc., provided by the device. In the context of a gaming application, the distance between the compute device and the human face of the device operator can be used to manipulate movement and/or orientation of a character in the game, provide a camera zoom-in and zoom-out effect, etc. In the context of a security application, the distance between the compute device and the human face of the device operator can be used to confirm the device operator is at a proper distance from the device before one or more facial analysis operations, such as facial recognition, expression recognition, etc., are initiated.

Some compute devices utilize a depth sensor, also referred to herein as a distance sensor, to measure the distance from the device to a human operator. Examples of such depth sensors include infrared depth sensor, ultrasound depth sensor, laser-based depth sensors, etc. However, including such a depth sensor in a compute device increases the complexity of the device which, in turn, can increase device cost, increase device power consumption, increase the risk of device failure, etc. However, many compute devices already include cameras capable of capturing two-dimensional (2D) images of the faces of human operators of the device. Example human face distance estimation techniques disclosed herein take advantage of such cameras to estimate the distance between a camera of the compute device and the face of a human operator of the device, referred to herein as a human face distance, without the use of a depth sensor or associated depth information. As such, example human face distance estimation techniques disclosed herein can determine the human face distance for a compute device without the need for a depth sensor or similar distance measuring device.

Example human face distance estimation techniques disclosed herein estimate the human face distance for a compute device based on (i) information obtained from a 2D image captured by the device's camera, (ii) one or more known characteristics of the device's camera, and (iii) known anatomical facial information for humans, in general, and/or obtained for the particular device operator. As disclosed in further detail below, the information obtained from the 2D image captured by the device's camera includes the locations of 2D facial landmarks detected in the image, and corresponding relative three-dimensional (3D) locations of those facial landmarks obtained through 3D reconstruction of a face model based on the 3D image data. As disclosed in further detail below, the one or more known characteristics of the device's camera include the focal length of the device's camera. As disclosed in further detail below, the known anatomical facial information includes a known anatomical distance between a pair of the facial landmarks on a human face. In some examples, this known anatomical distance is based on an average or other representative distance determined for a human population. In some examples, this known anatomical distance may be learned or otherwise obtained for a particular human, such as a particular device operator, through one or more initial calibration procedures.

As disclosed in further detail below, example human face distance estimation techniques disclosed herein utilize (i) the information obtained from a 2D image captured by the device's camera, (ii) the known characteristic(s) of the device's camera, and (iii) the known anatomical facial information to recover the human face distance from the device's camera to at least one of the facial landmarks on the operator's face. In some examples, this human face distance is used to represent the distance of the device to the human operator. In some example human face distance estimation techniques disclosed herein, respective distances from the device's camera to multiple corresponding different facial landmarks are estimated and then combined to obtain a human face estimate with improved accuracy relative to what can be achieved with human face distance estimation based on a single facial landmark. Some example human face distance estimation techniques disclosed herein further use the estimated human face distance to also estimate a position of the human face in 3D space.

As disclosed in further detail below, example human face distance estimation techniques disclosed herein utilize geometric properties and corresponding operations to estimate human face distance from (i) the information obtained from a 2D image captured by the device's camera, (ii) the known characteristic(s) of the device's camera, and (iii) the known anatomical facial information. In this way, disclosed example human face distance estimation techniques are computationally efficient and do not require complex depth estimation algorithms. Furthermore, disclosed example human face distance estimation techniques do not attempt to recover depth for an entire captured image. Rather, disclosed example human face distance estimation technique limit human face distance estimation to a finite number of facial landmarks, which further reduces computation complexity relative to distance estimation techniques that rely on recovering depth for an entire captured image. Therefore, example human face distance estimation techniques disclosed herein provide a low complexity, low cost and low power solution for human-machine interfaces that operate based on human face distance and/or position information.

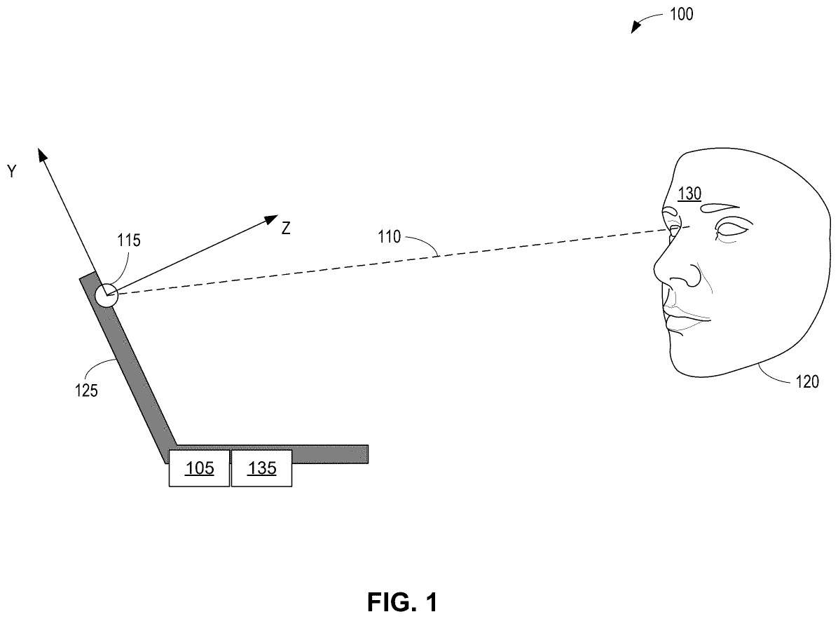

Turning to the figures, FIG. 1 is a block diagram of an example environment 100 including example facial user interface circuitry 105 to estimate a distance 110 between an example device camera 115 and a human face 120. In the illustrated example environment 100 of FIG. 1, the device camera 115 is included in, coupled to, or otherwise associated with an example compute device 125. The compute device 125 in the environment 100 is illustrated as an example laptop computer. However, the compute device 125 can be implemented by any type of compute device, such as, but not limited to, a server, a personal computer, a workstation, a mobile device (e.g., a cell phone, a smart phone, a tablet such as an iPad™), a personal digital assistant (PDA), a gaming console, a headset (e.g., an augmented reality (AR) headset, a virtual reality (VR) headset, etc.) or other wearable device, or any other type of computing and/or electronic device. Also, the device camera 115 in the environment 100 is illustrated as an example front-facing camera of the compute device 125. However, the device camera 115 can be implemented by any camera or other imaging device.

In the illustrated example of FIG. 1, the device camera 115 captures a 2D image of the human face 120. For example, the captured image can be a color image, a monochrome image, a thermal or infrared image, etc. The facial user interface circuitry 105 of the illustrated example accesses the 2D image captured by the device camera 115, as well as stored reference camera calibration data associated with the device camera 115, and stored reference anatomical facial data associated with the human face 120. As disclosed in further detail below, the facial user interface circuitry 105 of the illustrated example estimates the human face distance 110 between the device camera 115 and the human face 120 based on the reference camera calibration data, the reference anatomical facial data and two or more example facial landmarks 130 identified in the captured 2D image of the human face 120. In some examples, the facial user interface circuitry 105 also uses the estimated human face distance 110 to estimate a location of the human face 120 in 3D space, which may correspond to a 3D coordinate of one of the facial landmarks 130 in 3D space.

In the illustrated example of FIG. 1, the facial user interface circuitry 105 outputs, transmits or otherwise provides the estimated human face distance 110 and/or the estimated location of the human face 120 to one or more application(s) 135 executed or otherwise provided by the compute device 125. As disclosed above, the one or more applications 135, or the compute device 125 in general, can use the estimated human face distance 110 and/or the estimated location of the human face 120 as a user input to control one or more applications, such as gaming applications, security applications, etc., as described above. In some examples, the facial user interface circuitry 105 outputs, transmits or otherwise provides the estimated human face distance 110 and/or the estimated location of the human face 120 to a remote networked device, such as a server, a cloud platform, etc., which can use the human face distance 110 and/or the estimated location of the human face 120 as user input to control one or more applications provided by that remote networked device.

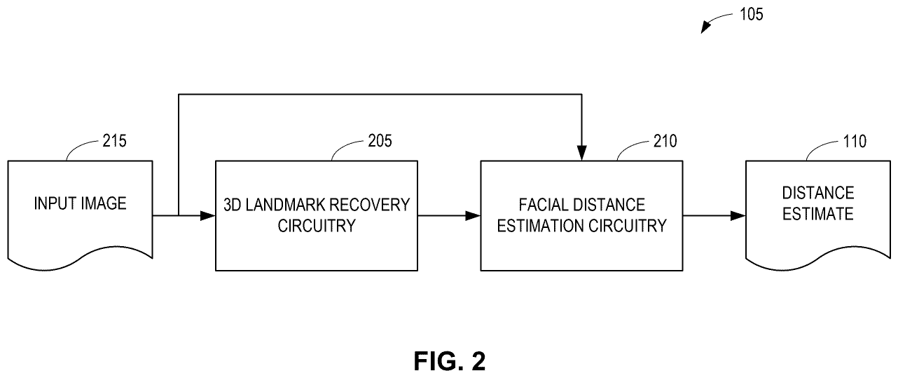

FIG. 2 is a block diagram of an example implementation of the facial user interface circuitry 105 of FIG. 1. The facial user interface circuitry 105 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the facial user interface circuitry 105 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example facial user interface circuitry 105 of FIG. 2 includes example 3D landmark recovery circuitry 205 and example facial distance estimation circuitry 210. The 3D landmark recovery circuitry 205 of the illustrated example accesses an example 2D input image 215 captured by the device camera 115 of the compute device 125. The 3D landmark recovery circuitry 205 processes the input image 215 to detect two or more of the facial landmarks 130 depicted in the input image 215. In some examples, the 3D landmark recovery circuitry 205 determines and outputs the locations of the facial landmarks 130 detected in the input image 215. For example, the 3D landmark recovery circuitry 205 can determine and output the locations of the detected facial landmarks 130 as 2D coordinates, such as (X, Y) coordinates, of the detected facial landmarks 130 in the input image 215.

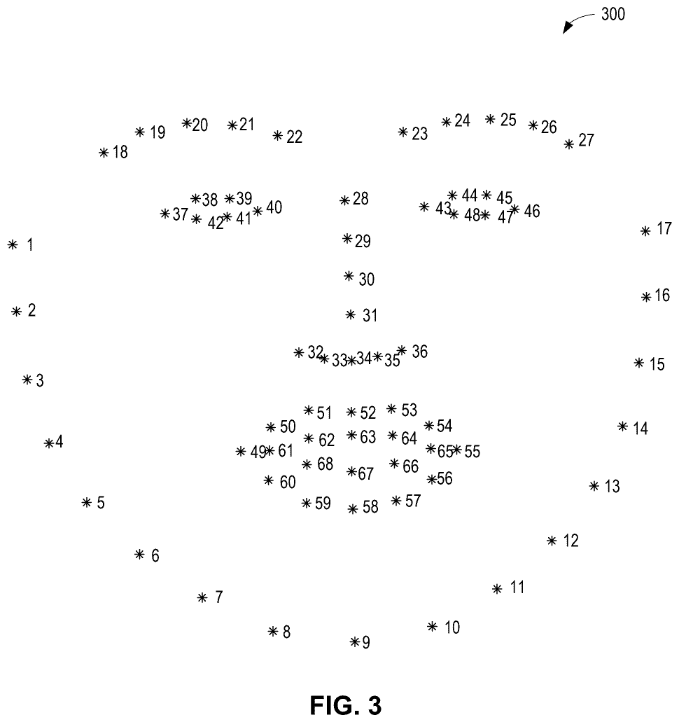

The 3D landmark recovery circuitry 205 may implement any existing or future facial landmark detection algorithm to detect facial landmarks in the input image 215. Additionally or alternatively, the 3D landmark recovery circuitry 205 may implement any existing or future landmark recovery algorithm that generates a 3D model of the human face 120 based on the input image 215, detects facial landmarks in the 3D model, and then projects then 3D landmarks back to a 2D plane corresponding to the input image 215. Example facial landmarks detectable by the 3D landmark recovery circuitry 205 are illustrated in FIG. 3.

FIG. 3 illustrates example facial landmarks 300 capable of being detected by the 3D landmark recovery circuitry 205 of the facial user interface circuitry 105. The facial user interface circuitry 105 uses the detected facial landmarks to estimate the human face distance 110 between the device camera 115 and the human face 120 in the example environment 100 of FIG. 1. FIG. 3 illustrates sixty-eight (68) example facial landmarks 300, some or all of which can be detected by the 3D landmark recovery circuitry 205. The example facial landmarks 300 are labeled from “1” to “68.” In some examples, the 3D landmark recovery circuitry 205 is configured to detect facial landmarks associated with the pupils of the human face 120. As such, in some examples, the 3D landmark recovery circuitry 205 is configured to detect at least the example landmarks “40” and “43” of FIG. 3, and output the locations (e.g., 2D coordinates) of the landmarks “40” and “43” in the input image 215.

Returning to FIG. 2, the 3D landmark recovery circuitry 205 of the illustrated example generates a 3D face model of the human face 120 based on the input image 215. The 3D landmark recovery circuitry 205 can implement any existing or future 3D facial modeling algorithm, head pose modeling algorithm, etc., to generate the 3D face model of the human face 120 based on the input image 215. For example, the 3D landmark recovery circuitry 205 may implement or otherwise utilize one or more artificial intelligence (AI) models (e.g., machine learning model(s), neural network(s), convolutional neural network(s), etc.) trained to infer a 3D face model of the human face 120 based on the input image 215. In some examples, the 3D face model generated by the 3D landmark recovery circuitry 205 is a 3D point cloud, a 3D mesh, etc., from which the 3D landmark recovery circuitry 205 can identify and extract vertices corresponding to facial landmarks. In some examples, the 3D face model generated/inferred by the 3D landmark recovery circuitry 205 may be up-to-scale, which means that the locations of the facial landmarks 130 on the 3D face model are relative locations, such as relative (X, Y, Z) coordinates, and not absolute locations, such as absolute physical (X, Y, Z) coordinates, in 3D space. For example, the locations of points on the 3D face model generated by the 3D landmark recovery circuitry 205 may be relative locations (e.g., relative coordinates) that are scaled versions of the absolute locations (e.g., absolute coordinates) of points (e.g., landmarks) on the human face 120 (e.g., such that the relative locations/coordinates correspond to are equal to the corresponding absolute locations/coordinates multiplied by a constant value that is the same across the locations/coordinates).

One reason the 3D face model generated by the 3D landmark recovery circuitry 205 may be up-to-scale is because the input image 215 is 2D and the human face 120 depicted in the captured image input image 215 could correspond to a large face that is far away from the device camera 115, or a small face that is close to the device camera 115. As a result, the 3D landmark recovery circuitry 205 may be able to generate a 3D face model of the human face 120 with model points (e.g., landmarks) having relatively accurate locations (e.g., coordinates) relative to each other, but the lack of depth information available from the 2D input image 215 may prevent the 3D landmark recovery circuitry 205 from being able to determine the absolute physical locations (e.g., coordinates) of the model points (e.g., landmarks) in 3D space.

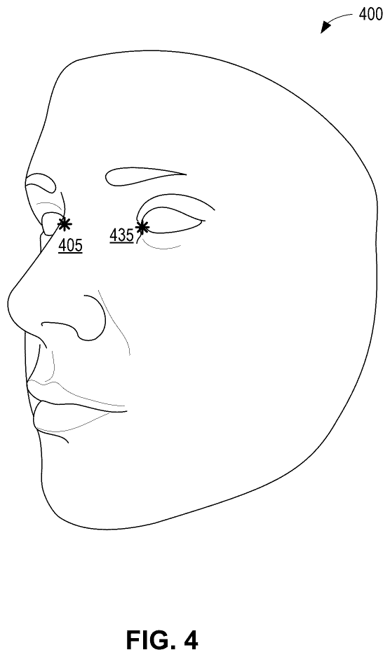

The 3D landmark recovery circuitry 205 of the illustrated example further identifies 3D facial landmarks on the generated 3D face model of the human face 120 that correspond respectively to the two or more 2D facial landmarks detected in the input image 215. The 3D landmark recovery circuitry 205 may implement any existing or future facial landmark identification algorithm to identify 3D facial landmarks on the generated 3D face model of the human face and correlate/match those identified 3D facial landmarks to the 2D facial landmarks detected in the input image 215. Example techniques for implementing 2D facial landmark detection, 3D facial modeling and 3D facial landmark identification and matching in the 3D landmark recovery circuitry 205 are described in U.S. Patent Publication 2025/0124596, which is titled “Head Pose Estimation in Computer Vision,” and which was published on Apr. 17, 2025. An example face model that may be generated by the 3D landmark recovery circuitry 205 is illustrated in FIG. 4.

FIG. 4 illustrates an example reconstructed 3D face model 400 capable of being generated by the 3D landmark recovery circuitry 205 of the facial user interface circuitry 105. The facial user interface circuitry 105 uses the face model 400 to identify relative 3D locations/coordinates of facial landmarks for use in estimating the human face distance 110 between the device camera 115 and the human face 120 in the example environment 100 of FIG. 1. In the illustrated example, the 3D landmark recovery circuitry 205 generates the reconstructed face model 400 from the input image 215 using one or more AI models (e.g., machine learning model(s), neural network(s), etc.) trained to infer the 3D model 400 from the 2D input image 215. In the illustrated example, the 3D landmark recovery circuitry 205 also identifies two or more 3D facial landmarks on the 3D face model 400 that correspond respectively to the two or more 2D facial landmarks detected by the 3D landmark recovery circuitry 205 in the input image 215. For example, the 3D landmark recovery circuitry 205 may identify example 3D facial landmarks 405 and 435 on the 3D face model 400 that corresponding respectively to the 2D facial landmarks “40” and “43” detected as pupil landmarks in the input image 215. In the illustrated example, the 3D landmark recovery circuitry 205 further determines and outputs the relative 3D locations (e.g., relative 3D coordinates) of the identified 3D facial landmarks on the 3D face model 400. For example, the 3D landmark recovery circuitry 205 may determine and output the relative 3D locations (e.g., relative 3D coordinates) of the 3D facial landmarks 405 and 435 identified on the 3D face model 400.

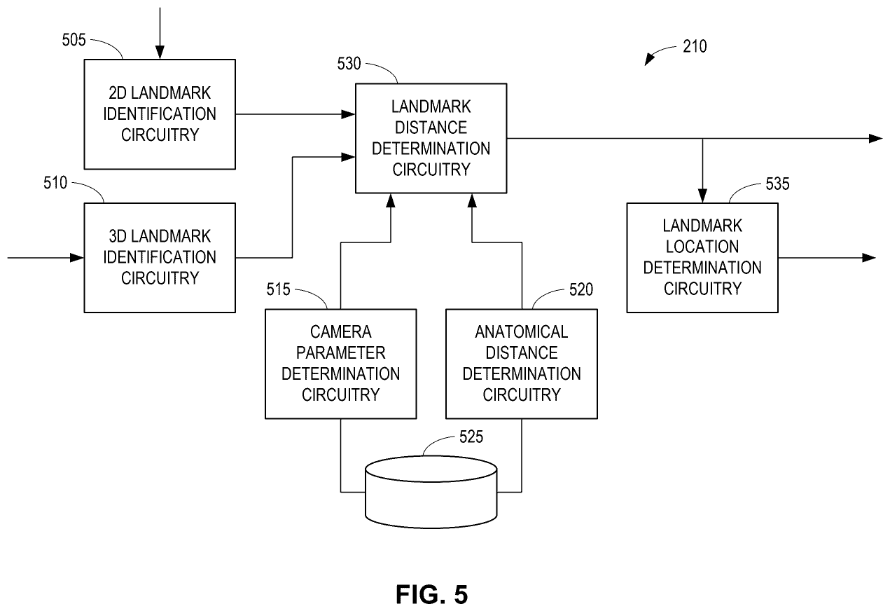

Returning to FIG. 2, the facial distance estimation circuitry 210 of the illustrated example estimates the human face distance 110 from the device camera 115 to the human face 120 of the example environment 100 based on the 2D facial landmark locations (e.g., 2D coordinates) and the corresponding 3D facial landmark relative locations (e.g., relative 3D coordinates) determined by the 3D landmark recovery circuitry 205 from the input image 215, as well as known characteristic(s) of the device camera 115 and known anatomical facial information associated with the human face 120. FIG. 5 is a block diagram of an example implementation of the facial distance estimation circuitry 210 of FIG. 2. The facial distance estimation circuitry 210 of FIG. 5 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the facial distance estimation circuitry 210 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

The example facial distance estimation circuitry 210 of FIG. 5 includes example 2D landmark identification circuitry 505, example 3D landmark identification circuitry 510, example camera parameter determination circuitry 515, example anatomical distance determination circuitry 520, example reference data storage 525, example landmark distance determination circuitry 530 and example landmark location determination circuitry 535. The 2D landmark identification circuitry 505 of the illustrated example identifies two or more of the facial landmarks 130 depicted in the input image 215 captured by the device camera 115 and obtains 2D locations (e.g., 2D coordinates) of the identified 2D facial landmarks. In some examples, the 2D landmark identification circuitry 505 identifies the two or more facial landmarks and obtains their 2D locations/coordinates in the input image 215 from the 3D landmark recovery circuitry 205, as described above. In some examples, the 2D landmark identification circuitry 505 implements any existing or future facial landmark detection algorithm to detect facial landmarks in the input image 215.

The 3D landmark identification circuitry 510 of the illustrated example obtains the relative 3D locations (e.g., the relative 3D coordinates) for the two or more facial landmarks identified by the 2D landmark identification circuitry 505 (which may have been obtained from the 3D landmark recovery circuitry 205). As described above, the relative 3D locations/coordinates are for facial landmarks on the 3D face model 400 reconstructed by the 3D landmark recovery circuitry 205 from the input image 215, and which correspond to the 2D facial landmarks identified in the input image 215. As such, in the illustrated example, 3D landmark identification circuitry 510 obtains the relative 3D locations/coordinates corresponding to the 2D facial landmarks identified in the input image 215 from the 3D landmark recovery circuitry 205, which determines the relative 3D locations/coordinates as described above.

The camera parameter determination circuitry 515 of the illustrated example obtains known characteristics of the device camera 115. For example, the reference data storage 525 can store calibration data and/or other reference data that describes characteristics, also referred to herein as parameters, of the device camera 115. In some examples, the camera parameter determination circuitry 515 retrieves the calibration data and/or other reference data for the device camera 115 from the reference data storage 525. As disclosed in further detail, the characteristics of the device camera 115 obtained by the camera parameter determination circuitry 515 from the calibration data and/or other reference data retrieved from the reference data storage 525 may include the focal length of the device camera 115, the principal point of the device camera 115, etc.

The anatomical distance determination circuitry 520 of the illustrated example obtains known anatomical facial information, also referred to as reference anatomical facial information, associated with the human face 120 depicted in the input image 215 captured by the device camera 115. As disclosed in further detail below, the known/reference anatomical facial information includes distances between one or more pairs of facial landmarks on a human face, referred to as facial landmark distances. For example, the anatomical facial information may include a facial landmark distance between the pair of facial landmarks “40” and “43” corresponding to pupils in the example of FIG. 3. In some examples, the anatomical facial information may include facial landmark distance(s) between one or more other pairs of the facial landmarks “1” to “68” depicted in FIG. 3. In some examples, the reference data storage 525 can store the facial landmark distance(s) and/or any other known/reference anatomical facial information, and the anatomical distance determination circuitry 520 retrieves that data from the reference data storage 525.

In some examples, the reference facial landmark distance(s) stored in the reference data storage 525 and obtained by the anatomical distance determination circuitry 520 is (are) based on average and/or other representative facial landmark distances determined for a human population. In some examples, the reference facial landmark distance(s) stored in the reference data storage 525 and obtained by the anatomical distance determination circuitry 520 is (are) learned or otherwise obtained by the anatomical distance determination circuitry 520 for a particular human, such as a particular device operator, through one or more initial calibration procedures and stored in the reference data storage 525. In some such examples, the anatomical distance determination circuitry 520 may utilize user identification information to select and retrieve the particular reference facial landmark distance(s) associated with the user corresponding to the human face 120 depicted in the input image 215 captured by the device camera 115.

As described above, the reference data storage 525 of the illustrated example stores calibration data and/or other reference data that describes characteristics of the device camera 115, and stores reference facial landmark distance(s) and/or other reference anatomical information associated with human faces. The reference data storage 525 can be implemented by any numbers and/or types of storage devices, memories, etc. For example, the reference data storage 525 can be implemented by one or more of the local memory 1313, the volatile memory 1314, the non-volatile memory 1316, and/or the mass storage discs or devices 1328 described in further detail below.

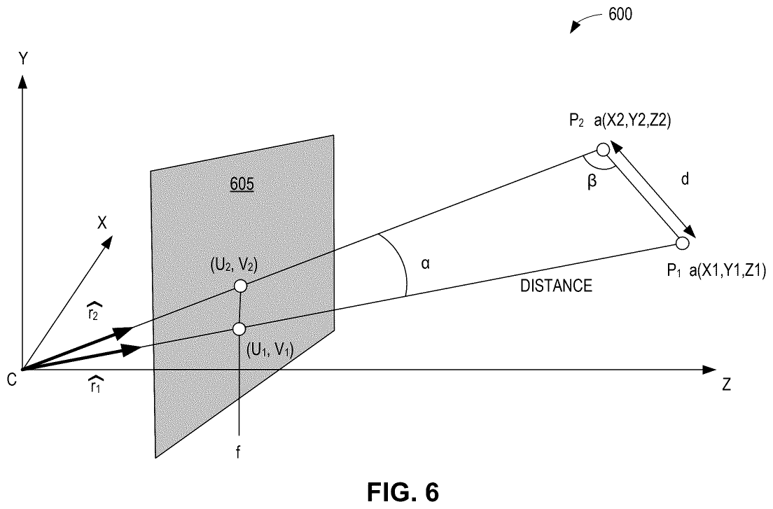

The landmark distance determination circuitry 530 of the illustrated example estimates the human face distance 110 from the device camera 115 to the human face 120 of the example environment 100 based on the 2D facial landmark locations (e.g., 2D coordinates) obtained by the 2D landmark identification circuitry 505, the corresponding 3D facial landmark relative locations (e.g., relative 3D coordinates) obtained by the 3D landmark identification circuitry 510, the reference characteristic(s) of the device camera 115 obtained by the camera parameter determination circuitry 515, and the reference anatomical facial information obtained by the anatomical distance determination circuitry 520. Operation of the landmark distance determination circuitry 530 is described in connection with FIGS. 6-8. FIGS. 6-8 illustrate example geometric relationships and operations utilized by the landmark distance determination circuitry 530 of the facial distance estimation circuitry 210 to estimate the distance 110 between the device camera 115 and the human face 120 in the example environment 100 of FIG. 1.

FIG. 6 illustrates example geometry 600 utilized by the landmark distance determination circuitry 530 for human face distance estimation. With reference to the example geometry 600 of FIG. 6, the landmark distance determination circuitry 530 obtains the 2D facial landmark locations for a pair of facial landmarks 130 detected in the input image 215 captured by the device camera 115, as described above. In the example geometry 600, the pair of facial landmarks 130 is represented by facial landmarks P₁ and P₂, and the 2D facial landmark locations for the facial landmarks P₁ and P₂ are represented by the 2D facial landmark coordinates (u₁, v₁) and (u₂, v₂), respectively. With reference to the example geometry 600 of FIG. 6, the landmark distance determination circuitry 530 also obtains the corresponding 3D facial landmark relative locations of the facial landmarks P₁ and P₂ based on the generated face model, as described above. In the example geometry 600, the 3D facial landmark relative locations for the facial landmarks P₁ and P₂ are represented by the 3D facial landmark relative coordinates a(X₁, Y₁, Z₁) and a(X₂, Y₂, Z₂), respectively, where “a” is a scale factor. As described above, the 3D coordinates of the facial landmarks P₁ and P₂ obtained from the generated face model are relative, or up-to-scale, and as a result the scale factor “a” is unknown.

With reference to the example geometry 600 of FIG. 6, the landmark distance determination circuitry 530 further obtains the camera characteristics of the device camera 115, as described above. In the example geometry 600, the landmark distance determination circuitry 530 obtains the focal length of the device camera 115, which is represented by “f” in the FIG. 6. In some examples, the landmark distance determination circuitry 530 also obtains the principal point, (pₓ, p_{y}), of the device camera 115.

With reference to the example geometry 600 of FIG. 6, the landmark distance determination circuitry 530 also obtains reference anatomical facial information associated with the facial landmarks P₁ and P₂, as described above. In the example geometry 600 of FIG. 6, the reference anatomical facial information include a reference anatomical distance between the facial landmarks P₁ and P₂, represented by “d” in FIG. 6. In some examples, the facial landmarks P₁ and P₂ correspond to pupil landmarks, such as the 2D facial landmarks “40” and “43” described above. In some such examples, the reference anatomical distance d is a reference interpupillary distance between the pupil facial landmarks P₁ and P₂. For example, the reference anatomical distance d can be equal to a reference interpupillary distance of 6.3 centimeters (cm) or some other average or reference value representative of a given human population. In some examples, the reference anatomical distance d can be a reference interpupillary distance obtained for a particular individual (e.g., per device user) via one or more calibration procedures or in any other manner, as described above.

After obtaining the foregoing input information, the landmark distance determination circuitry 530 operates to estimate the distance from the device camera 115, represented by “C” in the example geometry 600 of FIG. 6, to one or the facial landmarks in the pair of facial landmarks P₁ and P₂. For example, the landmark distance determination circuitry 530 may estimate the distance from the device camera C to the facial landmark P₁, which corresponds to the line segment “PIC” in the example geometry 600 of FIG. 6. The landmark distance determination circuitry 530 then outs the estimated distance from the device camera C to the facial landmark P₁ as the estimated human face distance 110.

To estimate the distance PIC between the device camera C and the facial landmark P₁, the landmark distance determination circuitry 530 begins by computing normalized rays, also referred to as normalized vectors, that represent the corresponding directions from the device camera C to the 2D facial landmark coordinates (u₁, v₁) and (u₂, v₂) of the facial landmarks P₁ and P₂, respectively, in the image plane of the camera C corresponding to the 2D input image 215. In the example geometry 600 of FIG. 6, these rays are represented by [symbol] and [symbol] , respectively, and the image plane is modelled as example image plane 605. To compute these rays, the landmark distance determination circuitry 530 models the image plane 605 as corresponding to the captured input image 215 located a distance f from the camera C, with the distance f corresponding to the retrieved focal length of the device camera 115. The landmark distance determination circuitry 530 further models the camera C as pinhole camera centered in the middle of the image plane 605 and, thus, centered on the middle of the captured input image 215.

Using this model of the camera's image plane, the landmark distance determination circuitry 530 computes un-normalized rays, r₁ and r₂, emanating from the camera pinhole C to the 2D facial landmark coordinates (u₁, v₁) and (u₂, v₂) of the facial landmarks P₁ and P₂, respectively, according to Equation 1:

$${r}_{i} = {( \begin{matrix}{u}_{i} & {v}_{i} & f\end{matrix} )}^{T} , i = \{ 1 , 2 \} \qquad Equation 1$$

In other words, according to Equation 1, the landmark distance determination circuitry 530 computes the un-normalized ray rᵢ=(uᵢ vᵢ f)^{T} for the coordinates (uᵢ, vᵢ) of the i^{th} facial landmark Pᵢ as a vector including the 2D coordinates (uᵢ, vᵢ) of the facial landmark P₁ and the focal length f of the camera 115. The landmark distance determination circuitry 530 then computes the normalized rays [symbol] and [symbol] , emanating from the camera pinhole C to the 2D facial landmark coordinates (u₁, v₁) and (u₂, v₂) of the facial landmarks P₁ and P₂, respectively, by normalizing the un-normalized rays, r₁ and r₂ according to Equation 2:

$$\hat{{r}_{ι}} = \frac{{( \begin{matrix}{u}_{i} & {v}_{i} & f\end{matrix} )}^{T}}{‖ {r}_{i} ‖} = \frac{{( \begin{matrix}{u}_{i} & {v}_{i} & f\end{matrix} )}^{T}}{\sqrt{{u}_{i}^{2} + {v}_{i}^{2} + {f}^{2}}} \qquad Equation 2$$

According to Equation 3, the landmark distance determination circuitry 530 computes the normalized rays [symbol] and [symbol] by dividing the un-normalized rays r₁ and r₂ by their respective magnitudes.

Next, the landmark distance determination circuitry 530 computes an angle between the normalized rays [symbol] and [symbol] , which represent the corresponding directions from the device camera C to the 2D facial landmark coordinates (u₁, v₁) and (u₂, v₂) of the facial landmarks P₁ and P₂, respectively. In the example geometry 600 of FIG. 6, this angle is represented as “α.” In the illustrated example, the landmark distance determination circuitry 530 computes the angle α based on the scalar product between the normalized rays [symbol] and [symbol] according to Equation 3:

$$= cos α \qquad Equation 3$$

The landmark distance determination circuitry 530 also computes an angle between the normalized ray [symbol] , which represents the direction from the device camera C to the 2D facial landmark coordinate (u₂, v₂) of the facial landmark P₂, and another normalized ray representing a direction from the 3D facial landmark relative coordinate a(X₁, Y₁, Z₁) of the facial landmark P₁ to the 3D facial landmark relative coordinate a(X₂, Y₂, Z₂) of the facial landmark P₂. In the example geometry 600 of FIG. 6, this angle is represented as “B.”

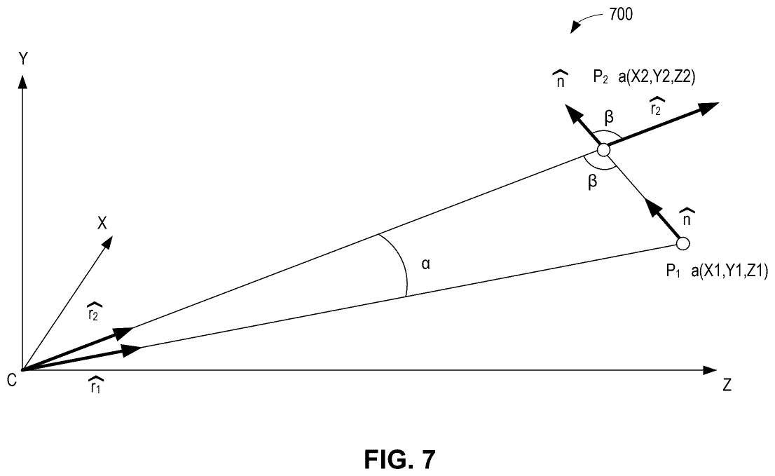

FIG. 7 illustrates example geometry 700 utilized by the landmark distance determination circuitry 530 to determine the angle β. In the example geometry 700 of FIG. 7, the normalized ray representing a direction from the 3D facial landmark relative coordinate a(X₁, Y₁, Z₁) of the facial landmark P₁ to the 3D facial landmark relative coordinate a(X₂, Y₂, Z₂) of the facial landmark P₂ is represented by “\hat{n}” The landmark distance determination circuitry 530 then computes the normalized ray \hat{n}, which represents the direction from the 3D facial landmark relative coordinate a(X₁, Y₁, Z₁) of the facial landmark P₁ to the 3D facial landmark relative coordinate a(X₂, Y₂, Z₂) of the facial landmark P₂ according to Equation 4:

$$\hat{n} = \frac{{P}_{2} - {P}_{1}}{‖ {P}_{2} - {P}_{1} ‖} \qquad Equation 4$$

In Equation 4, P₁ corresponds to (e.g., is equal to) the 3D facial landmark relative coordinate a(X₁, Y₁, Z₁) and P₂ corresponds to (e.g., is equal to) to the 3D facial landmark relative coordinate a(X₂, Y₂, Z₂). Thus, in Equation 4, the landmark distance determination circuitry 530 computes the normalized ray \hat{n} as the difference between the 3D facial landmark relative coordinates of the facial landmarks P₁ and P₂ divided by the magnitude of that distance. Furthermore, due to that division, the unknown scalar term “a” cancels from the numerator and denominator in Equation 4 and, thus, does not need to be determined.

As shown in the example geometry 700, the landmark distance determination circuitry 530 can compute the angle β between the normalized ray [symbol] , which represents the direction from the device camera C to the 2D facial landmark coordinate (u₂, v₂) of the facial landmark P₂, and the normalized ray \hat{n}, which represents the direction from the 3D facial landmark P₁ to the 3D facial landmark P₂, based on scalar product between [symbol] and ñ according to Equation 5:

$$\hat{n} = cos β \qquad Equation 5$$

Next, the landmark distance determination circuitry 530 employs vector algebra based on the law of sines to estimate the distance PIC from the device camera C to the facial landmark P₁ according to Equation 6:

$$\frac{‖ {P}_{2} - {P}_{1} ‖}{sin α} = \frac{‖ {P}_{1} ‖}{sin β} ⇒ \frac{d}{sin α} = \frac{distance}{sin β} \qquad Equation 6$$

In Equation 6, the distance PIC from the device camera C to the facial landmark P₁ is represented by “distance.” Also, Equation 6 assumes that the camera C as at the origin of the 3D space corresponding to the example environment 100 of FIG. 1 and, thus, the distance P₁C is equal to the distance to P₁, which is ∥P₁∥. Thus, in Equation 6, ∥P₁∥ is proportional to distance. Also, the distance between the relative locations of the facial landmarks P₁ and P₂, which is ∥P₂−P₁∥ in Equation 6, corresponds to and, thus, is proportional to the reference anatomical distance d between the facial landmarks P₁ and P₂. Thus, Equation 6 can be rearranged to solve for distance as shown in Equation 7:

$$distance = d \frac{sin β}{sin α} \qquad Equation 7$$

Thus, the landmark distance determination circuitry 530 can use Equation 7 directly to estimate the distance (distance) from the device camera C to the facial landmark P₁ by multiplying the reference anatomical distance d between the facial landmarks P₁ and P₂ by the ratio of the angles β and α. The landmark distance determination circuitry 530 then outputs the estimated distance (distance) from the device camera C to the facial landmark P₁ as the human face distance 110 (see FIG. 1).

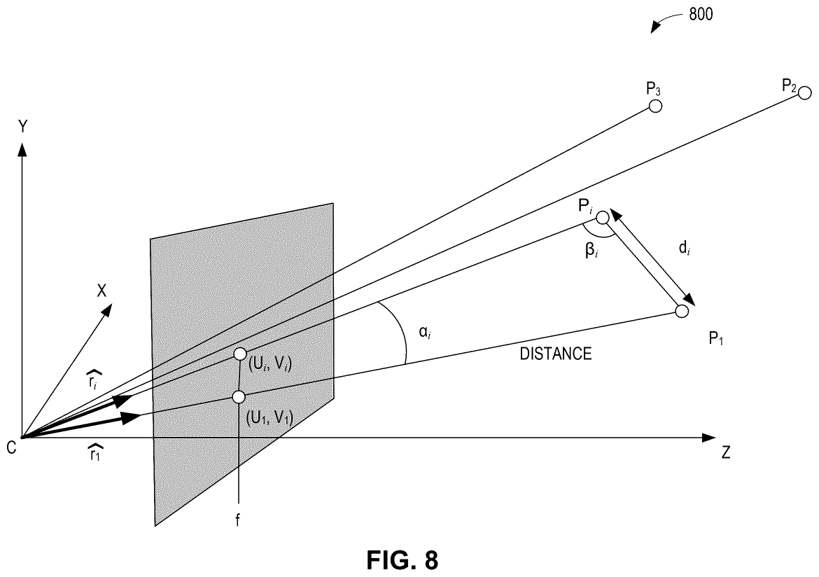

In some examples, the landmark distance determination circuitry 530 computes the human face distance 110 based on multiple facial landmark distances estimated for a given facial landmark, such as the facial landmark P₁, using multiple different pairs of facial landmarks (P₁, Pᵢ) that include the given facial landmark P₁. FIG. 8 illustrates example geometry 800 utilized by the landmark distance determination circuitry 530 for human face distance estimation based on multiple facial landmark distances estimated for the reference facial landmark P₁, using multiple different pairs of facial landmarks (Pᵢ, P₁) including the reference facial landmark P₁. For example, because the 2D projection of the facial landmarks P₁ and P₂ can be occluded for some poses, it may be beneficial to consider multiple (e.g., m) reference anatomical distances dᵢ for i=1, . . . m, between the facial landmark Pᵢ and multiple different facial landmarks Pᵢ for i=1, . . . , m, when estimating the human face distance based on the facial landmark. In some examples, the reference anatomical distances dᵢ for i=1, . . . m, between the facial landmark P₁ and multiple different facial landmarks P₁ for i=1, . . . , m, are average or reference values representative of a given human population. In some examples, the reference anatomical distances dᵢ for i=1, . . . m, between the facial landmark P₁ and multiple different facial landmarks P₁ for i=1, . . . , m, are obtained for a particular individual (e.g., per device user) via one or more calibration procedures or in any other manner. In some examples, the reference anatomical distances dᵢ for i=1, . . . m, between the facial landmark P₁ and multiple different facial landmarks Pᵢ for i=1, . . . , m, are extrapolations based on one particular known reference distance by scaling the entire face model generated by the 3D landmark recovery circuitry 205, such as the face model 400, by one or more known anatomical distances, such as the interpupillary distance described above.

With reference to FIG. 8, the landmark distance determination circuitry 530 performs human face distance estimation based on estimating multiple facial landmark distances for the reference facial landmark P₁, using multiple different pairs of facial landmarks (P₁, Pᵢ) including the reference facial landmark P₁ as follows. First, the landmark distance determination circuitry 530 compute angles αᵢ between different pairs of facial landmarks (Pᵢ, P₁) according to Equations 8-10:

$$= cos {α}_{i} where : \qquad Equation 8$$

$$= \frac{{r}_{i}}{‖ {r}_{i} ‖} and : \qquad Equation 9$$

$${r}_{i} = {( \begin{matrix}{u}_{i} & {v}_{i} & f\end{matrix} )}^{T} \qquad Equation 10$$

In other words, the landmark distance determination circuitry 530 computes un-normalized rays (or vectors), rᵢ emanating from the camera pinhole C to the 2D facial landmark coordinates (uᵢ, vᵢ) of the facial landmark Pᵢ, i=1, . . . , m, according to Equation 10. The landmark distance determination circuitry 530 also computes rays (or vectors) [symbol] for the facial landmark Pᵢ, i=1, . . . , m, by dividing the un-normalized rays rᵢ of Equation 10 by their respective magnitudes according to Equation 9. Then, the landmark distance determination circuitry 530 computes the angles αᵢ between different pairs of facial landmarks (Pᵢ, P₁) based on the scalar products between their respective normalized rays (or vectors) [symbol] and [symbol] according to Equation 8.

Next, the landmark distance determination circuitry 530 computes the angles βᵢ between the (i) normalized rays [symbol] , which represent the directions from the device camera C to the facial landmark Pᵢ (e.g., PᵢC), and (ii) the respective normalized difference rays, [symbol] , which represent the directions from the reference facial landmark P₁ to the facial landmark Pᵢ according to Equations 11 and 12:

$$= cos {β}_{i} where : \qquad Equation 11$$

$$= \frac{{P}_{i} - {P}_{1}}{‖ {P}_{i} - {P}_{1} ‖} \qquad Equation 12$$

In Equation 11, P₁ corresponds to (e.g., is equal to) the 3D facial landmark relative coordinate a(X₁, Y₁, Z₁) and P₁ corresponds to (e.g., is equal to) to the 3D facial landmark relative coordinate a(Xᵢ, Yᵢ, Zᵢ). Thus, in Equation 11, the landmark distance determination circuitry 530 computes the normalized ray [symbol] as the difference between the 3D facial landmark relative coordinates of the facial landmarks Pᵢ and P₁ divided by the magnitude of that distance. Furthermore, due to that division, the unknown scalar term “a” cancels from the numerator and denominator in Equation 11 and, thus, does not need to be determined. Furthermore, the landmark distance determination circuitry 530 computes the angle βᵢ based on the scalar product between the normalized rays [symbol] and [symbol] , according to Equation 11.

Next, the landmark distance determination circuitry 530 employs vector algebra based on the law of sines to determine the i^{th} estimate of the distance P₁C from the device camera C to the facial landmark P₁ based on the pair of facial landmarks (Pᵢ, P₁) according to Equation 13:

$$\frac{‖ {P}_{i} - {P}_{1} ‖}{sin {α}_{i}} = \frac{‖ {P}_{1} ‖}{sin {β}_{i}} ⇒ \frac{{d}_{i}}{sin {α}_{i}} = \frac{{distance}_{i}}{sin {β}_{i}} ⇒ \qquad Equation 13$$

In Equation 13, the i^{th} estimate of the distance PIC from the device camera C to the facial landmark P₁ is represented by “distanceᵢ.” Also, Equation 13 assumes that the camera C as at the origin of the 3D space corresponding to the example environment 100 of FIG. 1 and, thus, the distance P₁C is equal to the distance to P₁, which is ∥P₁∥. Thus, in Equation 6, ∥P₁∥ is proportional to distanceᵢ. Also, the distance between the relative locations of the given pair of facial landmarks P₁ and Pᵢ, which is ∥P₁−P₁∥ in Equation 6, corresponds to and, thus, is proportional to the reference anatomical distance dᵢ between the facial landmarks P₁ and Pᵢ. Thus, Equation 13 can be rearranged to solve for distance; as shown in Equation 14:

$${distance}_{i} = {d}_{i} \frac{sin {β}_{i}}{sin {α}_{i}}$$

Thus, the landmark distance determination circuitry 530 can use Equation 7 directly to determine the i^{th} estimate of the distance (distanceᵢ) from the device camera C to the facial landmark P₁ by multiplying the reference distance dᵢ between the facial landmarks P₁ and Pᵢ by the ratio of the angles βᵢ and αᵢ.

Next, the landmark distance determination circuitry 530 averages the different estimates, distanceᵢ, of the distance (distanceᵢ) from the device camera C to the facial landmark P₁ to determine an output estimated distance (distance) from the device camera C to the facial landmark P₁. In some examples, the landmark distance determination circuitry 530 computes this average distance (distance) as a weighted average of the different estimates, distanceᵢ, according to Equation 15:

$$distance = \frac{{\sum }_{i} {distance}_{i} sin {α}_{i}}{{\sum }_{i} sin {α}_{i}} \qquad Equation 15$$

In Equation 15, the landmark distance determination circuitry 530 weights the i^{th} estimate of the distance (distanceᵢ) from the device camera C to the facial landmark P₁ by the weight sin αᵢ, which is the sine of the angle αᵢ Such a weighting can help ensure that ambiguous distance estimates for which the angle αᵢ is small have less contribution to the output estimated distance (distance) than more accurate distance estimates for which the angle αᵢ is large.

Returning to FIG. 5, the landmark location determination circuitry 535 estimates 3D coordinates of one or more of the facial landmarks 130 in 3D space, such as the 3D coordinates of the facial landmark P₁, based on the estimated distance(s) (distance) determined for those landmark(s). For example, the landmark location determination circuitry 535 estimates the 3D coordinates of the facial landmark P₁ by multiplying the normalized ray (or vector) [symbol] representing the direction of that facial landmark P₁ by the distance, distance, to that facial landmark P₁ according to Equation 16:

$${P}_{1} = distance \cdot \qquad Equation 16$$

In Equation 16, the distance, distance, to the facial landmark P₁ can be the distance determined using one (1) pair of facial landmarks according to Equation 7, or the distance determined using one multiple pairs of facial landmarks according to Equation 15.

In the illustrated example of FIG. 5, the landmark distance determination circuitry 530 outputs the estimated distance (distance) from the device camera C to the facial landmark P₁ as the human face distance 110 (see FIG. 1). In the illustrated example of FIG. 5, the landmark location determination circuitry 535 outputs the estimated 3D coordinates of the reference facial landmark P₁ as the location of the human face 120 in 3D space.

In summary, the facial distance estimation circuitry 210 identifies facial landmarks Pᵢ in a 2D image 215 captured with a camera 115, computes, or in other words generates, respective rays [symbol] , that represent corresponding directions from the camera to respective 2D locations (uᵢ, vᵢ) of the facial landmark Pᵢ in an image plane 605 corresponding to the 2D image 215, and outputs a human face distance 110 between the camera 115 and a physical location of one of the facial landmarks (e.g., P₁) in 3D space, with the distance 110 being based on the respective rays [symbol] and respective relative 3D locations (e.g., a(Xᵢ, Yᵢ, Zᵢ)) corresponding to the facial landmarks. As described above, in some examples, the facial distance estimation circuitry 210 computes the human face distance 110 without depth information from a depth sensor.

In some examples, the facial distance estimation circuitry 210 computes, or in other words generates, the respective rays [symbol] based on a focal length, f, of the camera 115 and corresponding locations (uᵢ, vᵢ) of the facial landmarks in the 2D image 215. In some examples, the facial distance estimation circuitry 210 computes an angle (e.g., α or αᵢ) between a pair of the rays (e.g., ( [symbol] ) or ( [symbol] )) corresponding respectively to a pair of the facial landmarks (e.g., (Pᵢ, P₂) or (Pᵢ, P₁)) including the one of the facial landmarks (e.g., P₁). In some examples, the facial distance estimation circuitry 210 compute an angle (e.g., β or βᵢ) between (i) one ray of the pair of rays (e.g., [symbol] ) and (ii) another ray (e.g., \hat{n} or [symbol] ) that is based on a difference between a pair of the relative 3D locations (e.g., a(X₁, Y, Z₁) and a (X₂, Y₂, Z₂), or a(X₁, Y₁, Z₁) and a(Xᵢ, Yᵢ, Zᵢ) corresponding to the pair of the facial landmarks (e.g., (Pᵢ, P₂) or (Pᵢ, P₁)), and computes the human face distance 110 based on the angles (e.g., α or αᵢ, and β or βᵢ). In some examples, the facial distance estimation circuitry 210 computes the human face distance 110 based on the angles (e.g., α or αᵢ, and β or βᵢ) and a reference anatomical distance (e.g., d or dᵢ) between the pair of the facial landmarks in 3D space. In some examples, the facial distance estimation circuitry 210 computes the human face distance 110 based on a product of the reference anatomical distance (e.g., d or dᵢ) and a ratio of sines of the angles (e.g., α or αᵢ, and β or βᵢ) according to Equation 7 or 14. In some examples, the facial distance estimation circuitry 210 computes the physical location of the one of the facial landmarks in 3D space (e.g., P₁) based on the human face distance 110 and one of the rays (e.g., \hat{f}₁) that represents a corresponding one of the directions from the camera 115 to the 2D location (e.g., (u₁, vᵢ)) of the one of the facial landmarks (e.g., P₁) in the image plane 605.

In some examples, the human face distance 110 is a final output distance (e.g., distance), and the facial distance estimation circuitry 210 computes multiple initial distances (e.g., distanceᵢ) between the camera 115 and the physical location of the one of the facial landmarks (e.g., P₁) in 3D space, where respective ones of the initial distances (e.g., distanceᵢ) are based on corresponding different pairs (e.g., (P₁, P₁)) of the facial landmarks, with the different pairs (e.g., (P₁, P₁)) of the facial landmarks including the one of the facial landmarks (e.g., P₁) and respective other ones of the facial landmarks (e.g., P₁), and computes the final distance (e.g., distance) based on the initial distances (e.g., distanceᵢ). For example, the facial distance estimation circuitry 210 may compute the final distance (e.g., distance) based on an average of the initial distances (e.g., distanceᵢ). As another example, the facial distance estimation circuitry 210 may compute the final distance (e.g., distance) based on a weighted average of the initial distances (e.g., distanceᵢ) according to Equation 15, where the weighted average is based on respective weights (e.g., sin αᵢ) applied to corresponding ones of the initial distances (e.g., distanceᵢ). In some such examples, the facial distance estimation circuitry 210 computes the weights based on respective angles (e.g., at) between pairs of rays (e.g., ( [symbol] )) corresponding respectively to the different pairs of the facial landmarks (e.g., (Pᵢ, P₁)). In some such examples, the facial distance estimation circuitry 210 also computes the respective ones of the initial distances (e.g., distanceᵢ) based on reference anatomical distances (e.g., dᵢ) between the corresponding different pairs of the facial landmarks (e.g., (Pᵢ, P₁)).

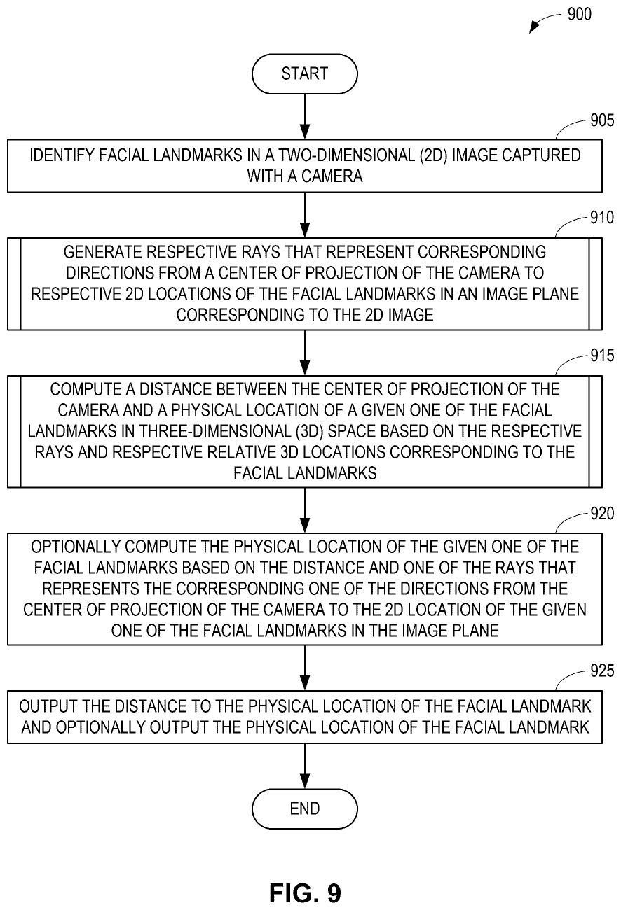

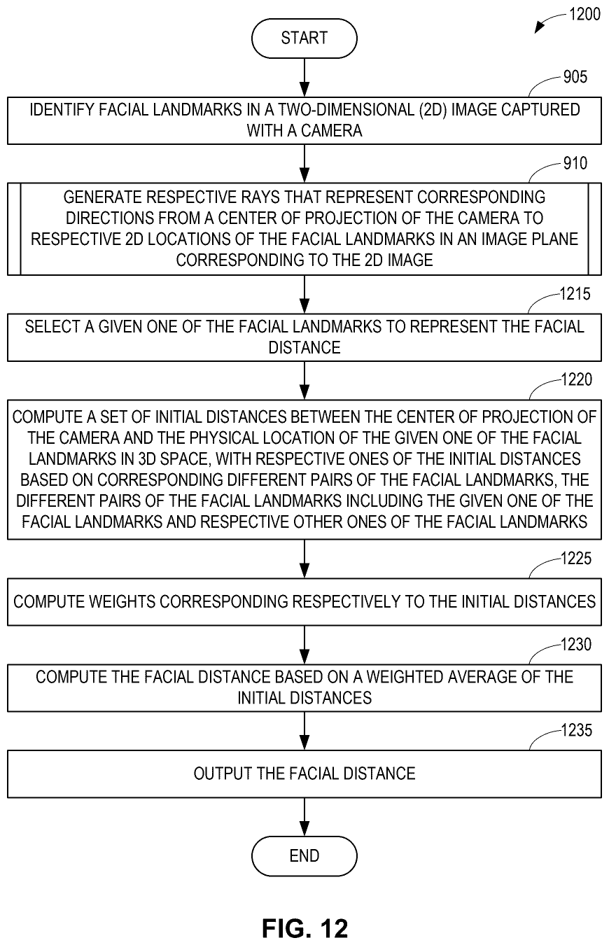

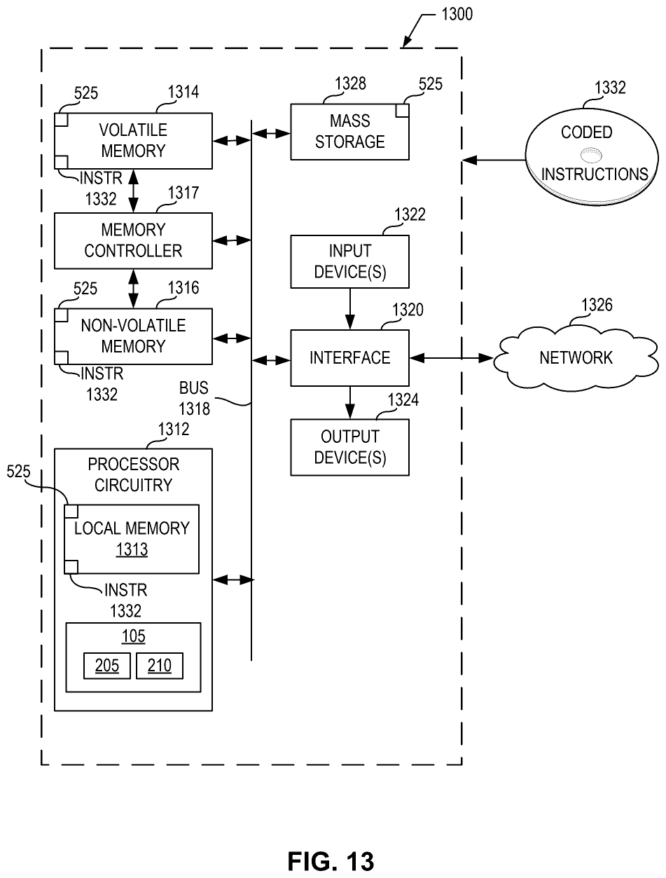

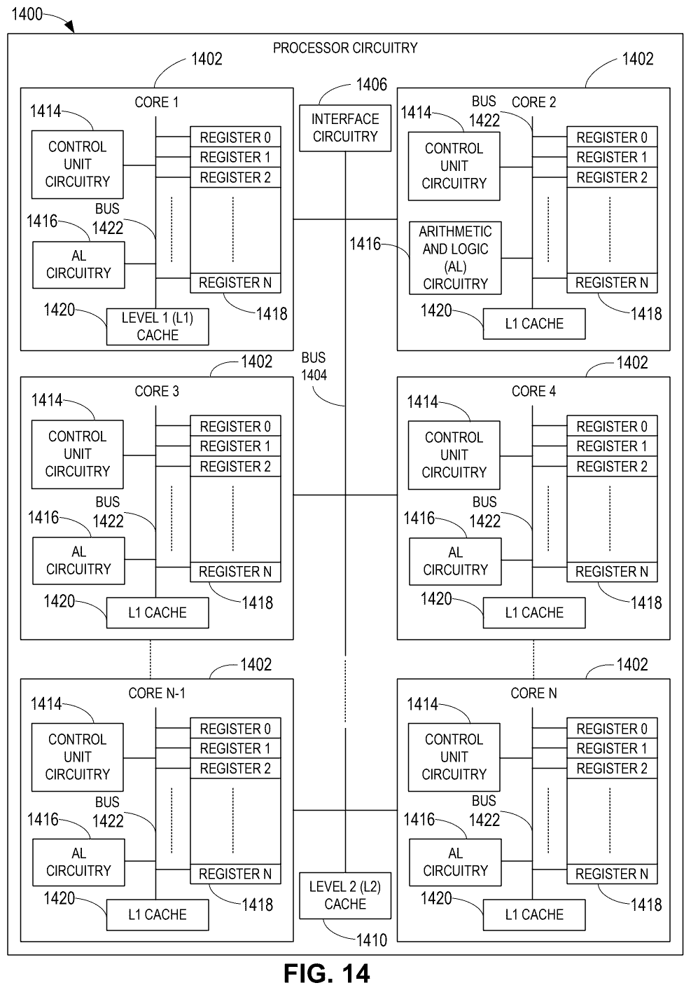

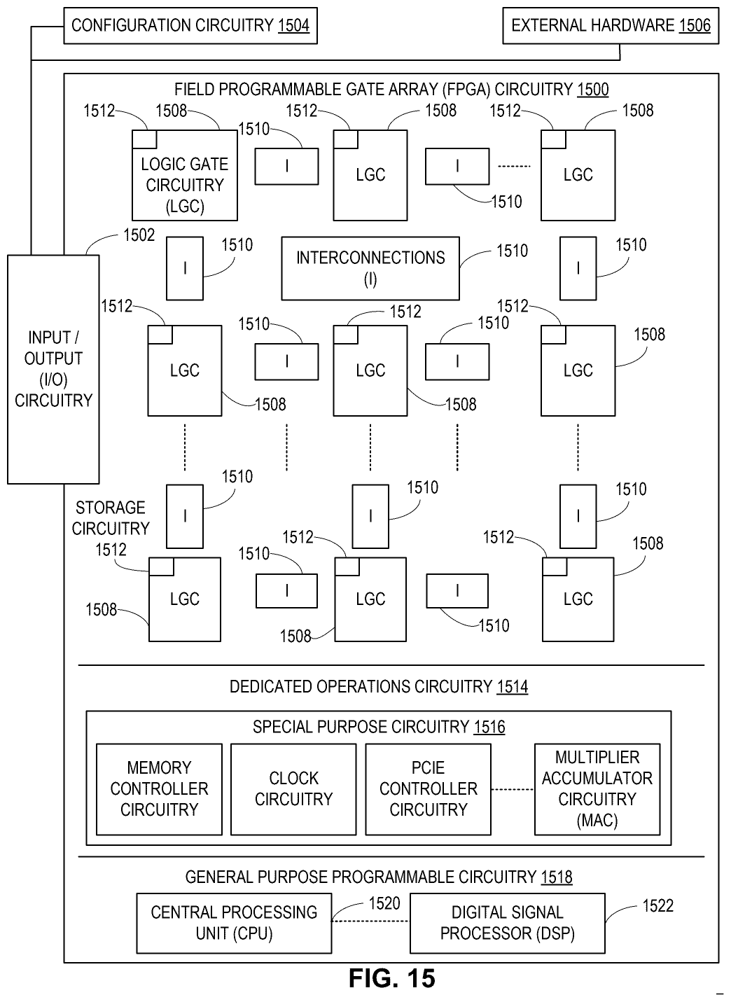

In some examples, the facial distance estimation circuitry 210 includes means for identifying 2D facial landmarks in images. For example, the means for identifying 2D facial landmarks in images may be implemented by the 2D landmark identification circuitry 505. In some examples, the 2D landmark identification circuitry 505 may be instantiated by programmable circuitry such as the example programmable circuitry 1312 of FIG. 13. For instance, the 2D landmark identification circuitry 505 may be instantiated by the example microprocessor 1400 of FIG. 14 executing machine executable instructions such as those implemented by at least block 905 of FIG. 9 and/or block 905 of FIG. 12. In some examples, the 2D landmark identification circuitry 505 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the 2D landmark identification circuitry 505 may be instantiated by any other combination of hardware, software, and/or firmware. For example, the 2D landmark identification circuitry 505 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the facial distance estimation circuitry 210 includes means for identifying 3D facial landmarks in facial models. For example, the means for identifying 3D facial landmarks in facial models may be implemented by the 3D landmark identification circuitry 510. In some examples, the 3D landmark identification circuitry 510 may be instantiated by programmable circuitry such as the example programmable circuitry 1312 of FIG. 13. For instance, the 3D landmark identification circuitry 510 may be instantiated by the example microprocessor 1400 of FIG. 14 executing machine executable instructions such as those implemented by at least block 915 of FIG. 9. In some examples, the 3D landmark identification circuitry 510 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the 3D landmark identification circuitry 510 may be instantiated by any other combination of hardware, software, and/or firmware. For example, the 3D landmark identification circuitry 510 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

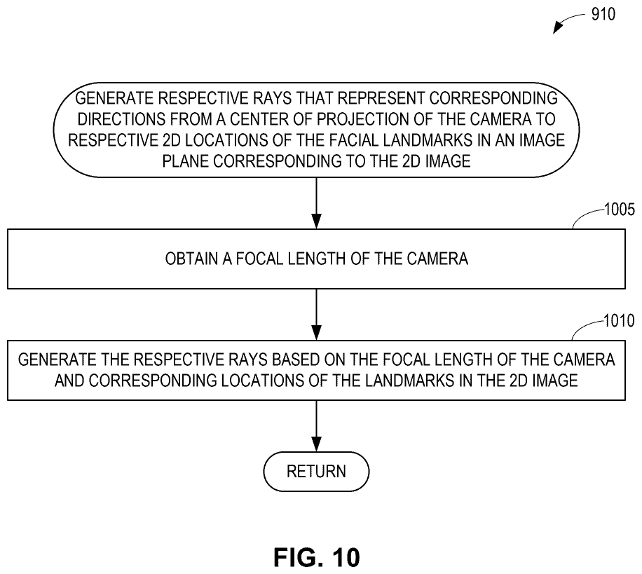

In some examples, the facial distance estimation circuitry 210 includes means for determining camera parameters. For example, the means for determining camera parameters may be implemented by the camera parameter determination circuitry 515. In some examples, the camera parameter determination circuitry 515 may be instantiated by programmable circuitry such as the example programmable circuitry 1312 of FIG. 13. For instance, the camera parameter determination circuitry 515 may be instantiated by the example microprocessor 1400 of FIG. 14 executing machine executable instructions such as those implemented by at least block 1005 of FIG. 10. In some examples, the camera parameter determination circuitry 515 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the camera parameter determination circuitry 515 may be instantiated by any other combination of hardware, software, and/or firmware. For example, the camera parameter determination circuitry 515 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

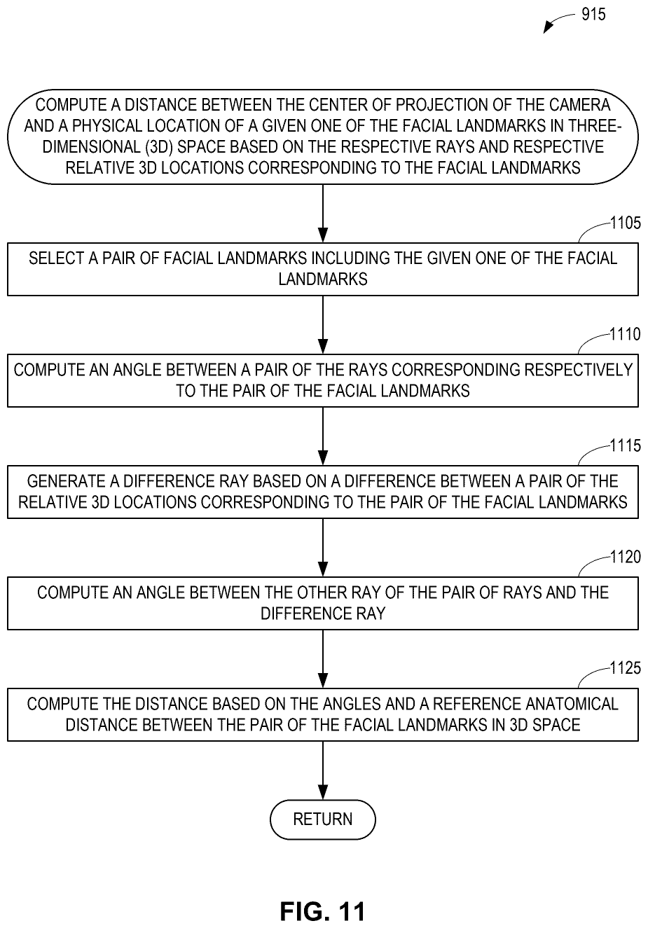

In some examples, the facial distance estimation circuitry 210 includes means for determining reference anatomical distances. For example, the means for determining reference anatomical distances may be implemented by the anatomical distance determination circuitry 520. In some examples, the anatomical distance determination circuitry 520 may be instantiated by programmable circuitry such as the example programmable circuitry 1312 of FIG. 13. For instance, the anatomical distance determination circuitry 520 may be instantiated by the example microprocessor 1400 of FIG. 14 executing machine executable instructions such as those implemented by at least block 1125 of FIG. 11. In some examples, the anatomical distance determination circuitry 520 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the anatomical distance determination circuitry 520 may be instantiated by any other combination of hardware, software, and/or firmware. For example, the anatomical distance determination circuitry 520 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the facial distance estimation circuitry 210 includes means for determining distances to facial landmarks. For example, the means for determining distances to facial landmarks may be implemented by the landmark distance determination circuitry 530. In some examples, the landmark distance determination circuitry 530 may be instantiated by programmable circuitry such as the example programmable circuitry 1312 of FIG. 13. For instance, the landmark distance determination circuitry 530 may be instantiated by the example microprocessor 1400 of FIG. 14 executing machine executable instructions such as those implemented by at least blocks 910, 915 and 925 of FIG. 9, block 1010 of FIG. 10, blocks 1105-1125 of FIG. 11 and/or blocks 910-1235 of FIG. 12. In some examples, the landmark distance determination circuitry 530 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the landmark distance determination circuitry 530 may be instantiated by any other combination of hardware, software, and/or firmware. For example, the landmark distance determination circuitry 530 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the facial distance estimation circuitry 210 includes means for determining locations of facial landmarks. For example, the means for determining locations of facial landmarks may be implemented by the landmark location determination circuitry 535. In some examples, the landmark location determination circuitry 535 may be instantiated by programmable circuitry such as the example programmable circuitry 1312 of FIG. 13. For instance, the landmark location determination circuitry 535 may be instantiated by the example microprocessor 1400 of FIG. 14 executing machine executable instructions such as those implemented by at least blocks 920-925 of FIG. 9. In some examples, the landmark location determination circuitry 535 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the landmark location determination circuitry 535 may be instantiated by any other combination of hardware, software, and/or firmware. For example, the landmark location determination circuitry 535 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the facial user interface circuitry 105 of FIG. 1 is illustrated in FIGS. 2 and 5, one or more of the elements, processes, and/or devices illustrated in FIGS. 2 and 5 may be combined, divided, re-arranged, omitted, eliminated, and/or implemented in any other way. Further, the example 3D landmark recovery circuitry 205 the example facial distance estimation circuitry 210, the example 2D landmark identification circuitry 505, the example 3D landmark identification circuitry 510, example camera parameter determination circuitry 515, the example anatomical distance determination circuitry 520, the example reference data storage 525, the example landmark distance determination circuitry 530, the example landmark location determination circuitry 535 and/or, more generally, the example facial user interface circuitry 105, may be implemented by hardware alone or by hardware in combination with software and/or firmware. Thus, for example, any of the example 3D landmark recovery circuitry 205 the example facial distance estimation circuitry 210, the example 2D landmark identification circuitry 505, the example 3D landmark identification circuitry 510, example camera parameter determination circuitry 515, the example anatomical distance determination circuitry 520, the example reference data storage 525, the example landmark distance determination circuitry 530, the example landmark location determination circuitry 535 and/or, more generally, the example facial user interface circuitry 105, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example facial user interface circuitry 105 may include one or more elements, processes, and/or devices in addition to, or instead of, those illustrated in FIGS. 1, 2 and/or 5, and/or may include more than one of any or all of the illustrated elements, processes and devices.

Flowchart(s) representative of example machine-readable instructions, which may be executed by programmable circuitry to implement and/or instantiate the facial distance estimation circuitry 210 of FIG. 2 and/or representative of example operations which may be performed by programmable circuitry to implement and/or instantiate the facial distance estimation circuitry 210 of FIG. 2, are shown in FIGS. 9-12. The machine-readable instructions may be one or more executable programs or portion(s) of one or more executable programs for execution by programmable circuitry such as the programmable circuitry 1312 shown in the example processor platform 1300 discussed below in connection with FIG. 13 and/or may be one or more function(s) or portion(s) of functions to be performed by the example programmable circuitry (e.g., an FPGA) discussed below in connection with FIGS. 14 and/or 15. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 9-12, many other methods of implementing the example facial distance estimation circuitry 210 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 9-12 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 9 is a flowchart representative of example machine-readable instructions and/or example operations 900 that may be executed, instantiated, and/or performed by programmable circuitry to implement the example facial distance estimation circuitry 210. The example machine-readable instructions and/or the example operations 900 of FIG. 9 begin at block 905, at which the 2D landmark identification circuitry 505 of the facial distance estimation circuitry 210 identifies facial landmarks in the 2D image 215 captured with the camera 115, as described above. At block 910, the landmark location determination circuitry 535 of the facial distance estimation circuitry 210 generates respective rays that represent corresponding directions from a center of projection of the camera 115 to respective 2D locations of the facial landmarks in an image plane 610 corresponding to the 2D image 215, as described above. At block 915, the landmark location determination circuitry 535 computes a distance (e.g., distance) between the center of projection of the camera 115 and a physical location of a given one of the facial landmarks (e.g., P₁) in 3D space based on the respective rays and respective relative 3D locations determined by the 3D landmark identification circuitry 510 for corresponding ones of the facial landmarks, as described above. At block 920, the landmark location determination circuitry 535 optionally computes the physical location of the given one of the facial landmarks (e.g. P₁) based on the distance (e.g., distance) and one of the rays (e.g., [symbol] ) that represents the corresponding one of the directions from the center of projection of the camera to the 2D location of the given one of the facial landmarks (e.g., P₁) in the image plane, as described above. At block 925, the landmark location determination circuitry 535 outputs the distance to the physical location of the facial landmark and optionally outputs the physical location of the facial landmark, as described above. The example machine-readable instructions and/or the example operations 900 of FIG. 9 then end.

FIG. 10 is a flowchart representative of example machine-readable instructions and/or example operations 910 that may be executed, instantiated, and/or performed by programmable circuitry to implement the processing at block 910 of FIG. 9. The example machine-readable instructions and/or the example operations 910 of FIG. 10 begin at block 1005, at which the camera parameter determination circuitry 515 of the facial distance estimation circuitry 210 obtains a focal length (e.g., f) of the camera 115. At block 1010, the landmark location determination circuitry 535 of the facial distance estimation circuitry 210 generates the respective rays based on the focal length (e.g., f) of the camera and corresponding locations (e.g., (uᵢ, vᵢ)) of the landmarks in the 2d image, as described above. The example machine-readable instructions and/or the example operations 910 of FIG. 10 then end.

FIG. 11 is a flowchart representative of example machine-readable instructions and/or example operations 915 that may be executed, instantiated, and/or performed by programmable circuitry to implement the processing at block 915 of FIG. 9. The example machine-readable instructions and/or the example operations 915 of FIG. 11 begin at block 1105 at which the landmark location determination circuitry 535 selects a pair of facial landmarks (e.g., P₂ and P₂) including the given one of the facial landmarks (e.g. P₁), as described above. At block 1110, the landmark location determination circuitry 535 computes an angle (e.g., a) between a pair of the rays (e.g., [symbol] and [symbol] ) corresponding respectively to the pair of the facial landmarks (e.g., P₂ and P₂), as described above. At block 1115, the landmark location determination circuitry 535 generates a difference ray (e.g., \hat{n}) based on a difference (e.g., P₂−P₁) between a pair of the relative 3d locations corresponding to the pair of the facial landmarks, as described above. At block 1120, the landmark location determination circuitry 535 computes an angle (e.g., β) between the other ray (e.g., [symbol] ) of the pair of rays and the difference ray (e.g., \hat{n}), as described above. At block 1125, the landmark location determination circuitry 535 computes the distance (e.g., distance) based on the angles (e.g., α and β) and a reference anatomical distance (e.g., d) between the pair of the facial landmarks in 3D space, as described above. The example machine-readable instructions and/or the example operations 915 of FIG. 11 then end.

FIG. 12 is a flowchart representative of second example machine-readable instructions and/or example operations 1200 that may be executed, instantiated, and/or performed by programmable circuitry to implement the example facial distance estimation circuitry 210. The example machine-readable instructions and/or the example operations 1200 of FIG. 12 begin at block 905, at which the 2D landmark identification circuitry 505 of the facial distance estimation circuitry 210 identifies facial landmarks in the 2D image 215 captured with the camera 115, as described above. At block 910, the landmark location determination circuitry 535 of the facial distance estimation circuitry 210 generates respective rays that represent corresponding directions from a center of projection of the camera 115 to respective 2D locations of the facial landmarks in an image plane 610 corresponding to the 2D image 215, as described above. At block 1215, the landmark distance determination circuitry 530 selects a given one of the facial landmarks (e.g., P₁) to be the reference landmark used to represent the facial distance 110, as described above. At block 1220, the landmark distance determination circuitry 530 computes a set of initial distances (e.g., distanceᵢ) between the center of projection of the camera 115 and the physical location of the given one of the facial landmarks (e.g., P₁) in 3D space, as described above. For example, at block 1220, the landmark distance determination circuitry 530 computes respective ones of the initial distances based on corresponding different pairs (e.g., Pi and P₁) of the facial landmarks, with the different pairs of the facial landmarks including the given one of the facial landmarks (e.g., P₁) and respective other ones of the facial landmarks (e.g., Pᵢ), as described above. At block 1225, the landmark distance determination circuitry 530 compute weights (e.g., sin αᵢ) corresponding respectively to the initial distances (e.g., distanceᵢ), as described above. At block 1230, the landmark distance determination circuitry 530 computes the facial distance 110 (e.g., distance) based on a weighted average of the initial distances (e.g., distanceᵢ), as described above. At block 1235, the landmark distance determination circuitry 530 outputs the facial distance 110 (e.g., distance), as described above. The example machine-readable instructions and/or the example operations 1200 then end.

FIG. 13 is a block diagram of an example programmable circuitry platform 1300 structured to execute and/or instantiate the example machine-readable instructions and/or the example operations of FIGS. 9-12 to implement the facial distance estimation circuitry 210 of FIG. 2. The programmable circuitry platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, VPUs, DSPs, and/or microcontrollers from any desired family or manufacturer. The programmable circuitry 1312 may be implemented by one or more semiconductor based (e.g., silicon based) devices. In this example, the programmable circuitry 1312 implements the example 3D landmark recovery circuitry 205 and/or the example facial distance estimation circuitry 210 of the example facial user interface circuitry 105. In some examples, the programmable circuitry 1312 implements the example 2D landmark identification circuitry 505, the example 3D landmark identification circuitry 510, the example camera parameter determination circuitry 515, the example anatomical distance determination circuitry 525, the example landmark distance determination circuitry 530 and/or the example landmark location determination circuitry 535 of the example facial distance estimation circuitry 210.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316. In some examples, the memory 1313, 1314 and/or 1316 implement the example reference data storage 525.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In some examples, the memory mass storage discs and/or devices 1328 implement the example reference data storage 525.

The machine-readable instructions 1332, which may be implemented by the machine-readable instructions of FIGS. 9-12, may be stored in the mass storage device 1328, in the volatile memory 1314, in the non-volatile memory 1316, and/or on at least one non-transitory computer-readable storage medium such as a CD or DVD which may be removable.

FIG. 14 is a block diagram of an example implementation of the programmable circuitry 1312 of FIG. 13. In this example, the programmable circuitry 1312 of FIG. 13 is implemented by a microprocessor 1400. For example, the microprocessor 1400 may be a general-purpose microprocessor (e.g., general-purpose microprocessor circuitry). The microprocessor 1400 executes some or all of the machine-readable instructions of the flowcharts of FIGS. 9-12 to effectively instantiate the circuitry of FIG. 2 as logic circuits to perform operations corresponding to those machine-readable instructions. In some such examples, the circuitry of FIG. 2 is instantiated by the hardware circuits of the microprocessor 1400 in combination with the machine-readable instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine-readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine-readable instructions and/or operations represented by the flowcharts of FIGS. 9-12.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2 cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the local memory 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating-point operations. In yet other examples, the AL circuitry 1416 may include first AL circuitry that performs integer-based operations and second AL circuitry that performs floating-point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure, such as by being distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

FIG. 15 is a block diagram of another example implementation of the programmable circuitry 1312 of FIG. 13. In this example, the programmable circuitry 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine-readable instructions. However, once configured, the FPGA circuitry 1500 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine-readable instructions represented by the flowchart(s) of FIGS. 9-12 but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 9-12. In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 9-12. As such, the FPGA circuitry 1500 may be configured and/or structured to effectively instantiate some or all of the operations/functions corresponding to the machine-readable instructions of the flowchart(s) of FIGS. 9-12 as dedicated logic circuits to perform the operations/functions corresponding to those software instructions in a dedicated manner analogous to an ASIC. Therefore, the FPGA circuitry 1500 may perform the operations/functions corresponding to the some or all of the machine-readable instructions of FIGS. 9-12 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine-readable instructions of FIGS. 9-12 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1312 of FIG. 13, many other approaches are contemplated. For example, FPGA circuitry may include an on-board CPU, such as one or more of the example CPU 1520 of FIG. 14. Therefore, the programmable circuitry 1312 of FIG. 13 may additionally be implemented by combining at least the example microprocessor 1400 of FIG. 14 and the example FPGA circuitry 1500 of FIG. 15. In some such hybrid examples, one or more cores 1402 of FIG. 14 may execute a first portion of the machine-readable instructions represented by the flowchart(s) of FIGS. 9-12 to perform first operation(s)/function(s), the FPGA circuitry 1500 of FIG. 15 may be configured and/or structured to perform second operation(s)/function(s) corresponding to a second portion of the machine-readable instructions represented by the flowcharts of FIG. 9-12, and/or an ASIC may be configured and/or structured to perform third operation(s)/function(s) corresponding to a third portion of the machine-readable instructions represented by the flowcharts of FIGS. 9-12.

It should be understood that some or all of the circuitry of FIG. 2 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1400 of FIG. 14 may execute machine-readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIG. 2 may be implemented within one or more virtual machines and/or containers executing on the microprocessor 1400 of FIG. 14.

In some examples, the programmable circuitry 1312 of FIG. 13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1312 of FIG. 13, which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

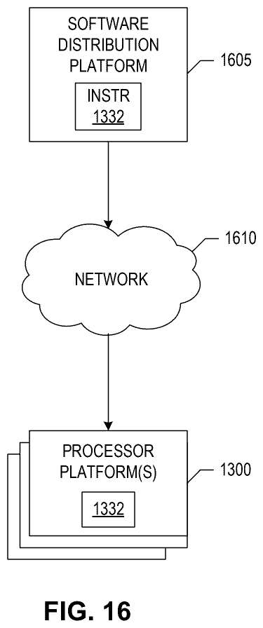

A block diagram illustrating an example software distribution platform 1605 to distribute software such as the example machine-readable instructions 1332 of FIG. 13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine-readable instructions 1332 of FIG. 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine-readable instructions 1332, which may correspond to the example machine-readable instructions of FIGS. 9-12, as described above. The one or more servers of the example software distribution platform 1605 are in communication with an example network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1332 from the software distribution platform 1605. For example, the software, which may correspond to the example machine-readable instructions of FIG. 9-12, may be downloaded to the example programmable circuitry platform 1300, which is to execute the machine-readable instructions 1332 to implement the facial distance estimation circuitry 210. In some examples, one or more servers of the software distribution platform 1605 periodically offer, transmit, and/or force updates to the software (e.g., the example machine-readable instructions 1332 of FIG. 13) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement human face distance estimation or, in other words, estimate the distance between a device camera and a human face of a device operator. Disclosed systems, apparatus, articles of manufacture, and methods improve the efficiency of using a computing device by estimating the distance from the camera of the computing device to a human face of an operator of the device without the need for a depth sensor or similar distance measuring device. Instead, disclosed systems, apparatus, articles of manufacture, and methods take advance of 2D imaging cameras already included in many computing devices, and utilize geometric properties and corresponding operations rather than complex facial modeling techniques, to estimate the human face distance for the computing device based on (i) information obtained from a 2D image captured by the device's camera, (ii) one or more known characteristics of the device's camera, and (iii) known anatomical facial information for humans, in general, and/or obtained for the particular device operator. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus comprising interface circuitry, machine-readable instructions, and at least one programmable circuit to be programmed based on machine-readable instructions to identify facial landmarks in a two-dimensional (2D) image captured with a camera, compute respective rays that represent corresponding directions from the camera to respective 2D locations of the facial landmarks in an image plane corresponding to the 2D image, and compute a distance between the camera and a physical location of one of the facial landmarks in three-dimensional (3D) space, the distance based on the respective rays and respective relative 3D locations corresponding to the facial landmarks.

Example 2 includes the apparatus of example 1, wherein one or more of the at least one programmable circuit is to compute the distance without depth information from a depth sensor.

Example 3 includes the apparatus of example 1 or example 2, wherein one or more of the at least one programmable circuit is to compute the respective rays based on a focal length of the camera and corresponding locations of the facial landmarks in the 2D image.

Example 4 includes the apparatus of any one of examples 1 to 3, wherein one or more of the at least one programmable circuit is to compute an angle between a pair of the rays corresponding respectively to a pair of the facial landmarks including the one of the facial landmarks, compute an angle between one ray of the pair of rays and another ray that is based on a difference between a pair of the relative 3D locations corresponding to the pair of the facial landmarks, and compute the distance based on the angles.

Example 5 includes the apparatus of example 4, wherein one or more of the at least one programmable circuit is to compute the distance based on the angles and a reference anatomical distance between the pair of the facial landmarks in 3D space.

Example 6 includes the apparatus of example 5, wherein one or more of the at least one programmable circuit is to compute the distance based on a product of the reference anatomical distance and a ratio of sines of the angles.

Example 7 includes the apparatus of any one of examples 1 to 6, wherein one or more of the at least one programmable circuit is to compute the physical location of the one of the facial landmarks in 3D space based on the distance and one of the rays that represents a corresponding one of the directions from the camera to the 2D location of the one of the facial landmarks in the image plane.

Example 8 includes the apparatus of any one of examples 1 to 7, wherein the distance is a final distance, and one or more of the at least one programmable circuit is to compute a plurality of initial distances between the camera and the physical location of the one of the facial landmarks in 3D space, respective ones of the initial distances based on corresponding different pairs of the facial landmarks, the different pairs of the facial landmarks including the one of the facial landmarks and respective other ones of the facial landmarks, and compute the final distance based on the initial distances.

Example 9 includes the apparatus of example 8, wherein one or more of the at least one programmable circuit is to compute the final distance based on an average of the initial distances.

Example 10 includes the apparatus of example 8, wherein one or more of the at least one programmable circuit is to compute the final distance based on a weighted average of the initial distances, the weighted average based on respective weights applied to corresponding ones of the initial distances.

Example 11 includes the apparatus of example 10, wherein one or more of the at least one programmable circuit is to compute the weights based on respective angles between pairs of rays corresponding respectively to the different pairs of the facial landmarks.

Example 12 includes the apparatus of example 10, wherein one or more of the at least one programmable circuit is to compute the respective ones of the initial distances based on reference anatomical distances between the corresponding different pairs of the facial landmarks.

Example 13 includes the apparatus of any one of examples 1 to 12, wherein one or more of the at least one programmable circuit is to manipulate at least one of movement or orientation of a character in a gaming application based on the computed distance.

Example 14 includes the apparatus of any one of examples 1 to 12, wherein one or more of the at least one programmable circuit is to initiate at least one of facial recognition or expression recognition based on the computed distance.

Example 15 includes at least one non-transitory computer-readable medium comprising computer-readable instructions to cause at least one programmable circuit to at least identify facial landmarks in a two-dimensional (2D) image captured with a camera, generate, based on a focal length of the camera, respective vectors that represent corresponding directions from the camera to respective 2D coordinates of the facial landmarks in an image plane corresponding to the 2D image, and output a distance between the camera and a physical location of one of the facial landmarks in three-dimensional (3D) space, the distance based on the respective vectors and respective relative 3D coordinates corresponding to the facial landmarks.

Example 16 includes the at least one non-transitory computer-readable medium of example 15, wherein the computer-readable instructions are to cause one or more of the at least one programmable circuit to compute an angle between a pair of the vectors corresponding respectively to a pair of the facial landmarks including the one of the facial landmarks, compute an angle between one vector of the pair of vectors and another vector that is based on a difference between a pair of the relative 3D coordinates corresponding to the pair of the facial landmarks, and compute the distance based on the angles and a reference anatomical distance between the pair of the facial landmarks in 3D space.

Example 17 includes the at least one non-transitory computer-readable medium of example 15 or example 16, wherein the computer-readable instructions are to cause one or more of the at least one programmable circuit to compute coordinates corresponding to the physical location of the one of the facial landmarks in 3D space based on the distance and one of the vectors that represents a corresponding one of the directions from the camera to the 2D coordinates of the one of the facial landmarks in the image plane.

Example 18 includes the at least one non-transitory computer-readable medium of any one of examples 15 to 17, wherein the distance is a final distance, the computer-readable instructions are to cause one or more of the at least one programmable circuit to compute a plurality of initial distances between the camera and the physical location of the one of the facial landmarks in 3D space, respective ones of the initial distances based on corresponding different pairs of the facial landmarks, the different pairs of the facial landmarks including the one of the facial landmarks and respective other ones of the facial landmarks, and compute the final distance based on the initial distances.

Example 19 includes a system comprising means for identifying facial landmarks in a two-dimensional (2D) image captured with a camera, means for computing a distance between a center of projection of the camera and a physical location of one of the facial landmarks in three-dimensional (3D) space, the means for computing to generate respective normalized vectors that represent corresponding directions from a center of projection of the camera to respective 2D coordinates of the facial landmarks in an image plane corresponding to the 2D image, the normalized vectors based on a focal length of the camera, and compute the distance based on the respective normalized vectors and respective relative 3D coordinates corresponding to the facial landmarks.

Example 20 includes the system of example 19, wherein the means for computing is to compute an angle between a pair of the normalized vectors corresponding respectively to a pair of the facial landmarks including the one of the facial landmarks, compute an angle between one normalized vector of the pair of normalized vectors and another normalized vector that is based on a difference between a pair of the relative 3D coordinates corresponding to the pair of the facial landmarks, and compute the distance based on the angles and a reference anatomical distance between the pair of the facial landmarks in 3D space.

Example 21 includes the system of example 19 or example 20, wherein the means for computing is to compute a plurality of initial distances between the center of projection of the camera and the physical location of the one of the facial landmarks in 3D space, respective ones of the initial distances based on corresponding different pairs of the facial landmarks, the different pairs of the facial landmarks including the one of the facial landmarks and respective other ones of the facial landmarks, and compute a final distance based on a weighted average of the initial distances, the weighted average based on respective weights applied to corresponding ones of the initial distances.

Example 22 includes the system of example 21, wherein the means for computing is to compute the respective ones of the initial distances based on reference anatomical distances between the corresponding different pairs of the facial landmarks.

Example 23 includes a method comprising identifying facial landmarks in a two-dimensional (2D) image captured with a camera, computing respective rays that represent corresponding directions from the camera to respective 2D locations of the facial landmarks in an image plane corresponding to the 2D image, and computing a distance between the camera and a physical location of one of the facial landmarks in three-dimensional (3D) space, the distance based on the respective rays and respective relative 3D locations corresponding to the facial landmarks.

Example 24 includes the method of example 23, wherein the distance is computed without depth information from a depth sensor.

Example 25 includes the method of example 23 or example 24, wherein the respective rays are computed based on a focal length of the camera and corresponding locations of the facial landmarks in the 2D image.

Example 26 includes the method of any one of examples 23 to 25, including computing an angle between a pair of the rays corresponding respectively to a pair of the facial landmarks including the one of the facial landmarks, computing an angle between one ray of the pair of rays and another ray that is based on a difference between a pair of the relative 3D locations corresponding to the pair of the facial landmarks, and computing the distance based on the angles.

Example 27 includes the method of example 26, wherein the distance is computed based on the angles and a reference anatomical distance between the pair of the facial landmarks in 3D space.

Example 28 includes the method of example 27, wherein the distance is computed based on a product of the reference anatomical distance and a ratio of sines of the angles.

Example 29 includes the method of any one of examples 23 to 28, including computing the physical location of the one of the facial landmarks in 3D space based on the distance and one of the rays that represents a corresponding one of the directions from the camera to the 2D location of the one of the facial landmarks in the image plane.

Example 30 includes the method of any one of examples 23 to 29, wherein the distance is a final distance, and including computing a plurality of initial distances between the camera and the physical location of the one of the facial landmarks in 3D space, respective ones of the initial distances based on corresponding different pairs of the facial landmarks, the different pairs of the facial landmarks including the one of the facial landmarks and respective other ones of the facial landmarks, and computing the final distance based on the initial distances.

Example 31 includes the method of example 30, wherein the final distance is computed based on an average of the initial distances.

Example 32 includes the method of example 30, wherein the final distance is computed based on a weighted average of the initial distances, the weighted average based on respective weights applied to corresponding ones of the initial distances.

Example 33 includes the method of example 32, including computing the weights based on respective angles between pairs of rays corresponding respectively to the different pairs of the facial landmarks.

Example 34 includes the method of example 32, including computing the respective ones of the initial distances based on reference anatomical distances between the corresponding different pairs of the facial landmarks.

Example 35 includes the method of any one of examples 23 to 34, including manipulating at least one of movement or orientation of a character in a gaming application based on the computed distance.

Example 36 includes the method of any one of examples 23 to 34, including initiating at least one of facial recognition or expression recognition based on the computed distance.

Example 37 includes at least one machine-readable medium comprising machine-readable instructions to cause at least one programmable circuit to perform the method of any one of examples 23 to example 36.

Example 38 includes an apparatus to perform the method of any one of examples 23 to example 36.

Example 39 includes a method performed by any one of the apparatus of examples 1 to example 14.

Example 40 includes at least one machine-readable medium comprising the machine-readable instructions of any one of the compute devices of examples 1 to example 14.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one programmable circuit to be programmed based on machine-readable instructions to:
identify facial landmarks in a two-dimensional (2D) image captured with a camera;
compute respective rays that represent corresponding directions from the camera to respective 2D locations of the facial landmarks in an image plane corresponding to the 2D image; and
compute a distance between the camera and a physical location of one of the facial landmarks in three-dimensional (3D) space, the distance based on the respective rays and respective relative 3D locations corresponding to the facial landmarks.

2. The apparatus of claim 1, wherein one or more of the at least one programmable circuit is to compute the distance without depth information from a depth sensor.

3. The apparatus of claim 1, wherein one or more of the at least one programmable circuit is to compute the respective rays based on a focal length of the camera and corresponding locations of the facial landmarks in the 2D image.

4. The apparatus of claim 1, wherein one or more of the at least one programmable circuit is to:
compute an angle between a pair of the rays corresponding respectively to a pair of the facial landmarks including the one of the facial landmarks;
compute an angle between one ray of the pair of rays and another ray that is based on a difference between a pair of the relative 3D locations corresponding to the pair of the facial landmarks; and
compute the distance based on the angles.

5. The apparatus of claim 4, wherein one or more of the at least one programmable circuit is to compute the distance based on the angles and a reference anatomical distance between the pair of the facial landmarks in 3D space.

6. The apparatus of claim 5, wherein one or more of the at least one programmable circuit is to compute the distance based on a product of the reference anatomical distance and a ratio of sines of the angles.

7. The apparatus of claim 1, wherein one or more of the at least one programmable circuit is to compute the physical location of the one of the facial landmarks in 3D space based on the distance and one of the rays that represents a corresponding one of the directions from the camera to the 2D location of the one of the facial landmarks in the image plane.

8. The apparatus of claim 1, wherein the distance is a final distance, and one or more of the at least one programmable circuit is to:
compute a plurality of initial distances between the camera and the physical location of the one of the facial landmarks in 3D space, respective ones of the initial distances based on corresponding different pairs of the facial landmarks, the different pairs of the facial landmarks including the one of the facial landmarks and respective other ones of the facial landmarks; and
compute the final distance based on the initial distances.

9. The apparatus of claim 8, wherein one or more of the at least one programmable circuit is to compute the final distance based on an average of the initial distances.

10. The apparatus of claim 8, wherein one or more of the at least one programmable circuit is to compute the final distance based on a weighted average of the initial distances, the weighted average based on respective weights applied to corresponding ones of the initial distances.

11. The apparatus of claim 10, wherein one or more of the at least one programmable circuit is to compute the weights based on respective angles between pairs of rays corresponding respectively to the different pairs of the facial landmarks.

12. The apparatus of claim 1, wherein one or more of the at least one programmable circuit is to at least one of (i) manipulate at least one of movement or orientation of a character in a gaming application based on the computed distance, or (ii) initiate at least one of facial recognition or expression recognition based on the computed distance.

13. At least one non-transitory computer-readable medium comprising computer-readable instructions to cause at least one programmable circuit to at least:
identify facial landmarks in a two-dimensional (2D) image captured with a camera;
generate, based on a focal length of the camera, respective vectors that represent corresponding directions from the camera to respective 2D coordinates of the facial landmarks in an image plane corresponding to the 2D image; and
output a distance between the camera and a physical location of one of the facial landmarks in three-dimensional (3D) space, the distance based on the respective vectors and respective relative 3D coordinates corresponding to the facial landmarks.

14. The at least one non-transitory computer-readable medium of claim 13, wherein the computer-readable instructions are to cause one or more of the at least one programmable circuit to:
compute an angle between a pair of the vectors corresponding respectively to a pair of the facial landmarks including the one of the facial landmarks;
compute an angle between one vector of the pair of vectors and another vector that is based on a difference between a pair of the relative 3D coordinates corresponding to the pair of the facial landmarks; and
compute the distance based on the angles and a reference anatomical distance between the pair of the facial landmarks in 3D space.

15. The at least one non-transitory computer-readable medium of claim 13, wherein the computer-readable instructions are to cause one or more of the at least one programmable circuit to compute coordinates corresponding to the physical location of the one of the facial landmarks in 3D space based on the distance and one of the vectors that represents a corresponding one of the directions from the camera to the 2D coordinates of the one of the facial landmarks in the image plane.

16. The at least one non-transitory computer-readable medium of claim 13, wherein the distance is a final distance, the computer-readable instructions are to cause one or more of the at least one programmable circuit to:
compute a plurality of initial distances between the camera and the physical location of the one of the facial landmarks in 3D space, respective ones of the initial distances based on corresponding different pairs of the facial landmarks, the different pairs of the facial landmarks including the one of the facial landmarks and respective other ones of the facial landmarks; and
compute the final distance based on the initial distances.

17. A system comprising:
means for identifying facial landmarks in a two-dimensional (2D) image captured with a camera;
means for computing a distance between a center of projection of the camera and a physical location of one of the facial landmarks in three-dimensional (3D) space, the means for computing to:
generate respective normalized vectors that represent corresponding directions from a center of projection of the camera to respective 2D coordinates of the facial landmarks in an image plane corresponding to the 2D image, the normalized vectors based on a focal length of the camera; and
compute the distance based on the respective normalized vectors and respective relative 3D coordinates corresponding to the facial landmarks.

18. The system of claim 17, wherein the means for computing is to:
compute an angle between a pair of the normalized vectors corresponding respectively to a pair of the facial landmarks including the one of the facial landmarks;
compute an angle between one normalized vector of the pair of normalized vectors and another normalized vector that is based on a difference between a pair of the relative 3D coordinates corresponding to the pair of the facial landmarks; and
compute the distance based on the angles and a reference anatomical distance between the pair of the facial landmarks in 3D space.

19. The system of claim 17, wherein the means for computing is to:
compute a plurality of initial distances between the center of projection of the camera and the physical location of the one of the facial landmarks in 3D space, respective ones of the initial distances based on corresponding different pairs of the facial landmarks, the different pairs of the facial landmarks including the one of the facial landmarks and respective other ones of the facial landmarks; and
compute a final distance based on a weighted average of the initial distances, the weighted average based on respective weights applied to corresponding ones of the initial distances.

20. The system of claim 19, wherein the means for computing is to compute the respective ones of the initial distances based on reference anatomical distances between the corresponding different pairs of the facial landmarks.
